(19) United States
(12) Patent Application Publication
(10) Pub. No.: US 2014/0184796 A1
(43) Pub. Date: Jul. 3, 2014

(54) METHOD AND APPARATUS FOR REMOTELY CONTROLLING A MICROPHONE

(71) Applicant: MOTOROLA SOLUTIONS, INC., Schaumburg, IL (US)

(72) Inventors: David E. Klein, Davie, FL (US); Tyrone D. Bekiares, Park Ridge, IL (US); Kevin J. O'Connell, Palatine, IL (US)

(73) Assignee: MOTOROLA SOLUTIONS, INC., Schaumburg, IL (US)

(21) Appl. No.: 13/728,376

(22) Filed: Dec. 27, 2012

(51) Int. Cl. H04R 29/00; H04N 7/18

(52) U.S. Cl. CPC H04R 29/004; H04N 7/18
USPC 348/148; 381/57; 348/231.4

(57) ABSTRACT

A method and vehicle-based communication system are provided that control a remote microphone by determining that one or more of the remote microphone and a user of the remote microphone is in a field of view (FOV) of a video camera and, in response, instructing the remote microphone to configure itself to receive ambient audio. In various embodiments, the remote microphone may configure itself, or be explicitly instructed to configure itself, to receive ambient audio by adjusting one or more of a beam forming or omni-directional pattern, potentially including noise cancellation algorithms to facilitate reception of ambient audio in contrast to user directed audio. When the one or more of the remote microphone and a user of the remote microphone no longer is in a FOV of the video camera, the method and vehicle-based communication system may instruct the remote microphone to reconfigure itself to receive user directed audio.

### FIELD OF THE INVENTION

The present invention relates generally to operating a microphone, and more particularly to remotely controlling an operation of the microphone.

### BACKGROUND OF THE INVENTION

In a public-safety environment, where a public safety officer may have a battery-operated, shoulder-mounted microphone and a vehicle-mounted video camera, it may be necessary to synchronize the microphone and the camera. Therefore a need exists for a method and apparatus for remotely controlling an operation of the microphone to synchronize it with the camera.

### BRIEF DESCRIPTION OF THE DRAWINGS

FIG. 1 is a block diagram illustrating a general operational environment in accordance with an embodiment of the present invention.

FIG. 2 is a block diagram of the mobile station of FIG. 1 in accordance with some embodiments of the present invention.

FIG. 3 is a block diagram of the battery-operated remote speaker microphone of FIG. 1 in accordance with some embodiments of the present invention.

FIG. 4 is a block diagram of the vehicle-mounted camera of FIG. 1 in accordance with some embodiments of the present invention.

FIG. 5 is a block diagram of the computer of FIG. 1 in accordance with some embodiments of the present invention.

FIG. 6 is a block diagram of the base station of FIG. 1 in accordance with some embodiments of the present invention.

FIG. 7 is a logic flow diagram illustrating a method of controlling an operation of a battery-operated microphone of FIG. 1 in accordance with some embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION OF THE INVENTION

To address the need for a method and apparatus for remotely controlling an operation of a battery-operated microphone to synchronize it with a vehicle-mounted camera, a method and vehicle-based communication system are provided that control a remote microphone by determining that one or more of the remote microphone and a user of the remote microphone is in a field of view (FOV) of a video camera and, in response, instructing the remote microphone to configure itself to receive ambient audio. In various embodiments, the remote microphone may configure itself, or be explicitly instructed to configure itself, to receive ambient audio by adjusting one or more of a beam forming or omni-directional pattern, potentially including noise cancellation algorithms to facilitate reception of ambient audio in contrast to user directed audio. When the one or more of the remote microphone and a user of the remote microphone no longer is in a field of view (FOV) of the video camera, the method and vehicle-based communication system may instruct the remote microphone to reconfigure itself to receive user directed audio.

Generally, an embodiment of the present invention encompasses a method for controlling a remote microphone. The method includes determining that one or more of the remote microphone and a user of the remote microphone is in a field of view (FOV) of a video camera and, in response to determining that one or more of the remote microphone and the user is in the FOV, instructing the remote microphone to configure itself to receive ambient audio.

Another embodiment of the present invention encompasses a vehicle-based communication system capable of controlling a remote microphone. The vehicle-based communication system includes a video camera and a processor that is configured to determine, by reference to the video camera, that one or more of the remote microphone and a user of the remote microphone is in a field of view (FOV) and, in response to determining that one or more of the remote microphone and the user is in the FOV, instruct the remote microphone to configure itself to receive ambient audio.

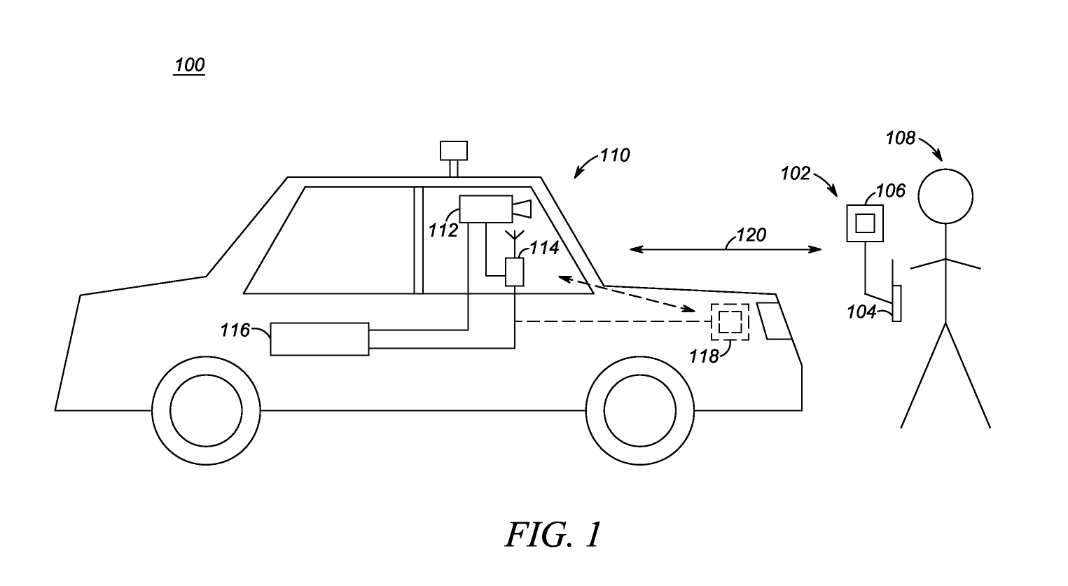

The present invention may be more fully described with reference to FIGS. 1-7. FIG. 1 is a block diagram of a general operational environment 100 in accordance with an embodiment of the present invention. Operational environment 100 includes a user-based communication system 102 in wireless communication with a vehicle-based communication system 110, such as communication system of a public safety vehicle, via an air interface 120. Air interface 120 includes a downlink (from the vehicle-based communication system to the user-based communication system) and an uplink (from the user-based communication system to the vehicle-based communication system). Each of the downlink and the uplink comprises multiple communication channels, including at least one signaling channel and at least one traffic channel.

Vehicle-based communication system 110 includes a vehicle-mounted video camera 112 and a vehicle-based base station 114 that each are coupled to a computer 116. Camera 112 may be further coupled to base station 114, so that the camera may communication with user-based communication system 102 and/or with public safety network without having to route signals to the computer. Vehicle-based communication system 110 further may include a vehicle-mounted remote speaker microphone (RSM) 118 coupled to one or more of base station 114 and computer 116.

User-based communication system 102 includes a battery-operated mobile station (MS) 104 coupled to a battery-operated remote speaker microphone (RSM) 106 via a wired connection or a short-range wireless connection. MS 104 may be mechanically coupled, for example, via a hooking mechanism, to a belt of a user 108, for example, a public safety officer, and RSM 106 may be mechanically coupled, for example, via a hooking mechanism, to a shoulder strap of the user. User 108 then may listen to, and input, audio communications into RSM 106 and RSM 106, in turn, transmits the user's audio communications to, and receives audio communications for the user from, vehicle-based communication system 110 via MS 104.

MS 104 preferably is a Public Safety (PS) radio that communicates with vehicle-based communication system 110 via short-range wireless protocol, such as Bluetooth® or a Wireless Local Area Network (WLAN) as described by the IEEE (Institute of Electrical and Electronics Engineers) 802.xx standards, for example, the 802.11 or 802.15 standards. However, MS 104 may be any portable wireless communication device, such as but not limited to a cellular telephone, a smartphone, a wireless-enabled hand-held computer or tablet computer, and so on.

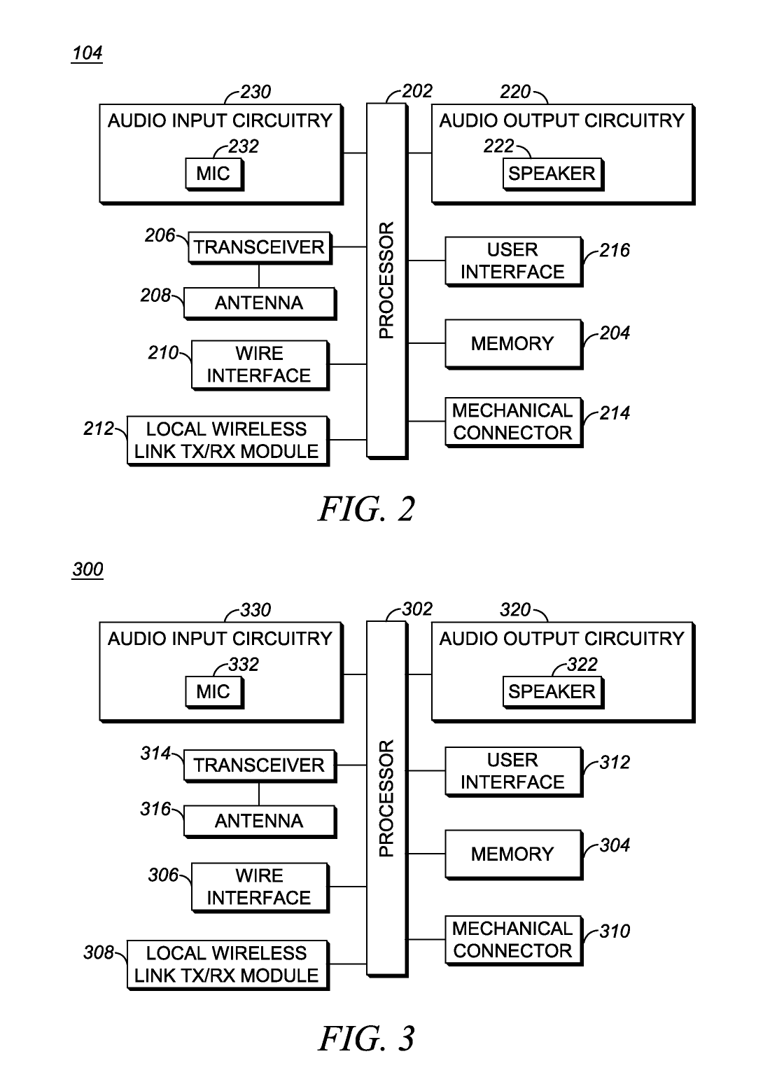

Referring now to FIG. 2, a block diagram is provided of MS 104 in accordance with some embodiments of the present invention. MS 104 operates under the control of a processor 202, such as one or more microprocessors, microcontrollers, digital signal processors (DSPs), combinations thereof or such other devices known to those having ordinary skill in the art. Processor 202 operates MS 104 according to data and instructions stored in an at least one memory device 204, such as random access memory (RAM), dynamic random access memory (DRAM), and/or read only memory (ROM) or equivalents thereof, that stores data and programs that may be executed by processor 202 so that the MS may perform the functions described herein.

MS 104 further includes a wireless transceiver 206 coupled to an antenna 208 and capable of exchanging wireless signals with vehicle-based communication system 110. MS 104 also includes one or more of a wireline interface 210 and a short-range, low power local wireless link transmit/receive module 212 that allow the MS to directly communicate with audio accessory 106, for example, via a wired link or a short-range wireless link such as a Bluetooth® link, a near field communication (NFC) link, or the like. In addition, MS 104 may include a mechanical connector 214 for coupling the MS to a user of the MS, for example, a belt clip locking mechanism for locking the MS onto a belt of a user or into an MS carrying case that is coupled to a belt of the user.

MS 104 also includes a interface 216 that provides a user of the MS with the capability of interacting with the MS, including inputting instructions into the MS. For example, user interface may include a Push-to-Talk button (PTT) key for initiating, and reserving a floor of, a PTT call. MS 104 further includes audio output circuitry 220 for audio output for listening by a user of the MS and audio input circuitry 230 for allowing a user to input audio signals into the MS. Audio output circuitry 220 includes a speaker 222 that receives the audio signals and allows audio output for listening by a user. Audio input circuitry 230 includes a microphone 232 that allows a user to input audio signals into the MS.

Processor 202 controls the operation of MS 104, including an exchange of audio communications with RSM 106, an exchange of radio frequency (RF) signals with vehicle-based communication system 110, and an enabling or disabling of audio input circuitry 230, and a reconfiguring of antenna 210, in response to signals from vehicle-based communication system 110.

Referring now to FIG. 3, a block diagram is provided of an audio accessory 300, such as RSM 106 and vehicle-mounted RSM 118, in accordance with some embodiments of the present invention. Audio accessory 300 includes a processor 302, such as one or more microprocessors, microcontrollers, digital signal processors (DSPs), combinations thereof or such other devices known to those having ordinary skill in the art. Processor 302 may control the operation of audio accessory 300 according to data and instructions stored in an at least one memory device 304, such as random access memory (RAM), dynamic random access memory (DRAM), and/or read only memory (ROM) or equivalents thereof, that stores data and programs that may be executed by processor 302 so that the audio accessory may perform the functions described herein.

Audio accessory 300 includes one or more of a wire interface 306 and a short-range, low power local wireless link transmit/receive module 308 that allow the audio accessory to directly communicate with other devices of FIG. 1, such as MS 104 in the case of RSM 106 and computer 116 in the case of vehicle-mounted RSM 118. Wireless link transmit/receive module 308 may support, for example, a Bluetooth® link, a near field communication (NFC) link, or the like. Audio accessory 300 further includes a mechanical connector 310 for coupling the audio accessory to a vehicle, in the case of vehicle-mounted RSM 118, or to a user of the audio accessory, for example, for hooking the audio accessory onto a belt of the user or onto a shoulder strap of the user, in the case of RSM 106.

Audio accessory 300 further includes audio output circuitry 320 for audio output for listening by a user of the RSM and audio input circuitry 330 for allowing a user to input audio signals into the RSM. Audio output circuitry 320 includes a speaker 322 that receives the audio signals and allows audio output for listening by a user. Audio input circuitry 330 includes a microphone 332 that allows a user to input audio signals into the RSM.

Audio accessory 300 also may include a user interface 312 that provides a user of the audio accessory, for example, in the case of RSM 106, with the capability of interacting with the RSM, including a PTT key for initiating, and reserving a floor of, a PTT call. Further, RSM includes a wireless transceiver 314 coupled to an antenna 316 for detecting audio signals in areas proximate to the RSM.

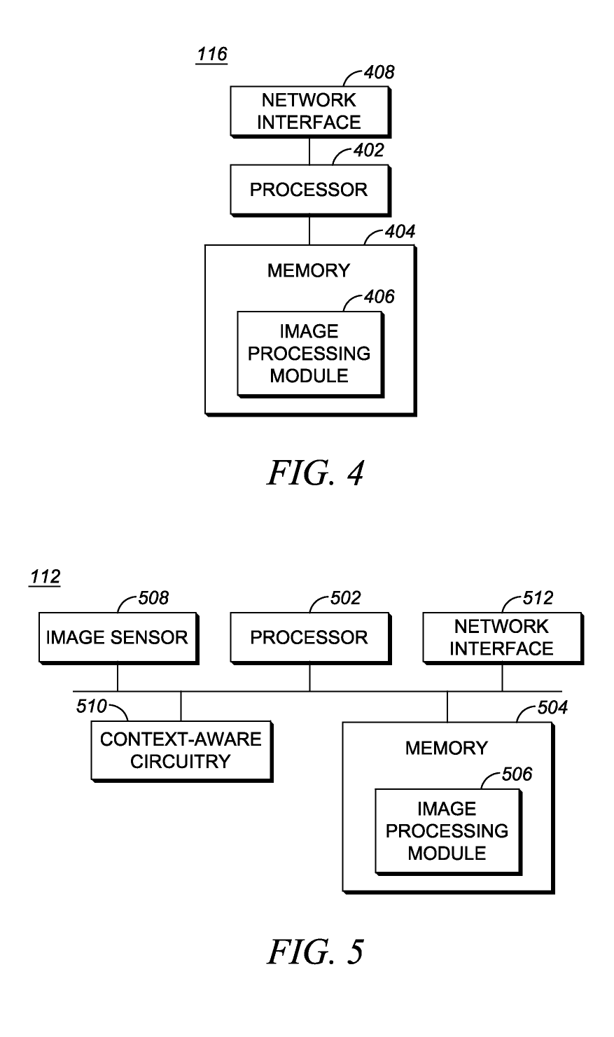

FIG. 4 is a block diagram of computer 116 in accordance with some embodiments of the present invention. Computer 116 includes a processor 402 such as one or more microprocessors, microcontrollers, digital signal processors (DSPs), combinations thereof or such other devices known to those having ordinary skill in the art. Processor 402 may control the operation of computer 116 according to data and instructions stored in an at least one memory device 404, such as random access memory (RAM), dynamic random access memory (DRAM), and/or read only memory (ROM) or equivalents thereof, that stores data and programs that may be executed by processor 402 so that the RSM may perform the functions described herein. At least one memory device 404 includes an image processing module 406 comprising data and programs that, when executed by processor 402, are able to recognize a particular feature in a received image. For example, as known in the art, image processing algorithms are able to detect, among many things, shapes, surface changes, changes in image brightness, object edges, facial features, image depth, and scene changes, and perform pattern recognition and matching. Computer 116 further includes one or more network interfaces 408 for connecting to other devices of vehicle-based communication system 110, such as devices 112, 114, and 118.

Referring now to FIG. 5, a block diagram is provided of vehicle-mounted camera 112 in accordance with some embodiments of the present invention. Camera 112 includes a processor 502 such as one or more microprocessors, microcontrollers, digital signal processors (DSPs), combinations thereof or such other devices known to those having ordinary skill in the art. Processor 502 may control the operation of camera 112 according to data and instructions stored in an at least one memory device 504, such as random access memory (RAM), dynamic random access memory (DRAM), and/or read only memory (ROM) or equivalents thereof, that stores data and programs that may be executed by processor 502 so that the RSM may perform the functions described herein. Optionally, least one memory device 504 may further include an image processing module 506, similar to image processing module 406, comprising data and programs that, when executed by processor 502, are able to recognize a particular feature in a received image.

Camera 112 further includes an image sensor 508 and context-aware circuitry 510 that are each coupled to processor 502. Image sensor 508 electronically captures a sequence of video frames (that is, a sequence of one or more still images), with optional accompanying audio, in a digital format. Although not shown, the images or video captured by the image/video sensor 508 may be stored in the at least one memory device 504, or may be sent directly to computer 116 via a network interface 512. Context-aware circuitry 510 may comprise any device capable of generating information used to determine a current Field of View (FOV). During operation, context-aware circuitry 510 provides processor 502 with information needed to determine a FOV. Processor 502 then determines a FOV and provides the FOV to computer 116 via network interface 512. In a similar manner, processor 502 provides any image/video obtained by image sensor 508 to computer 116, via network interface 512, for storage. However, in another embodiment of then present invention, camera 112 may have recording capabilities, for example, camera 112 may comprise a digital video recorder (DVR) wherein processor 502 stores images/video obtained by image sensor 508 in at least one memory device 504.

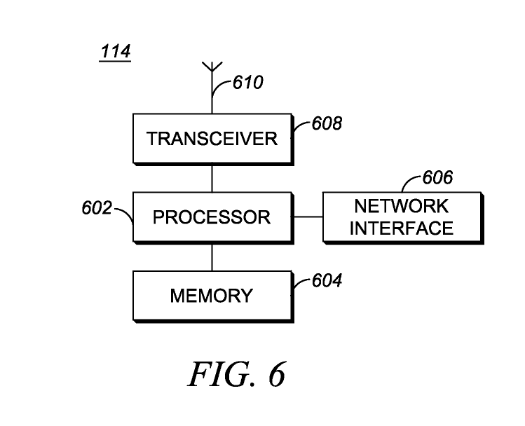

FIG. 6 is a block diagram of base station 114 in accordance with some embodiments of the present invention. Base station 114 includes a processor 602 such as one or more microprocessors, microcontrollers, digital signal processors (DSPs), combinations thereof or such other devices known to those having ordinary skill in the art. Processor 602 may control the operation of base station 114 according to data and instructions stored in an at least one memory device 604, such as random access memory (RAM), dynamic random access memory (DRAM), and/or read only memory (ROM) or equivalents thereof, that stores data and programs that may be executed by processor 402 so that the RSM may perform the functions described herein. Base station 114 further includes one or more network interfaces 606, for connecting to other devices of vehicle-based communication system 110, such as devices 112, 114, and 118, and a wireless transceiver 608 for exchanging wireless communications with user-based communication system 102, for example, with MS 104, and with a public safety network (not shown) via an antenna 610.

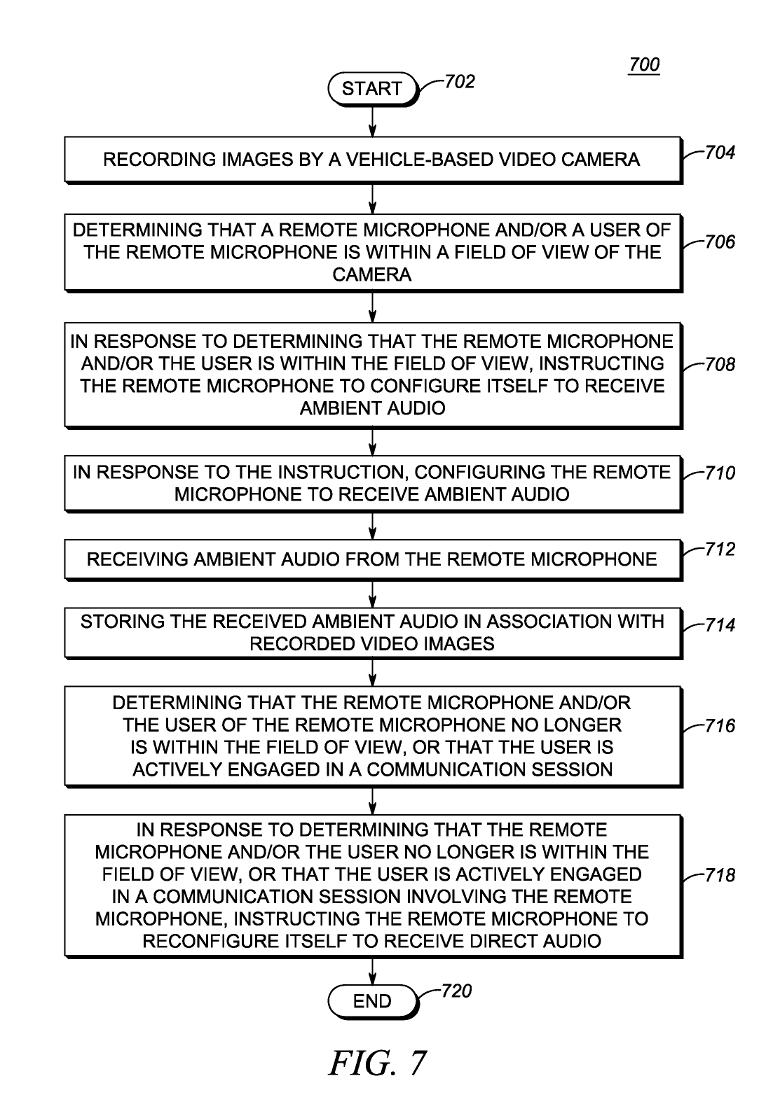

Referring now to FIG. 7, a logic flow diagram 700 is provided illustrating a controlling of an operation of vehicle-based communication system 110 in accordance with some embodiments of the present invention. Logic flow diagram 700 begins (702) when vehicle-based communication system 110 begins recording (704) images and, either before or after initiating the recording of images, determines (706) that a remote microphone, such as microphone 232 of MS 104 or microphone 332 of RSM 106 or RSM 118, or a user of such a remote microphone, that is, user 108, is within a field of view (FOV) of camera 112.

That is, in one embodiment of the present invention, image sensor 406 of camera 112 captures an image of a current FOV of the camera and the camera conveys the captured image to computer 116. In response to receiving the image, processor 402 of computer 116 determines whether one or more of user 108, MS 104, or RSM 118 is included in the image. For example, processor 402 may execute an image processing algorithm 406 maintained in at least one memory device 404 of the computer, which image processing algorithm may detect the presence of one or more of the user, MS 104, or RSM 118 in the image.

In another embodiment of the present invention, processor 502 of camera 112 may determine whether one or more of user 108, MS 104, or RSM 118 is included in the image by executing an image processing algorithm 406 maintained in at least one memory device 404.

In yet another embodiment of the present invention, processor 402 of camera 112 may receive information from context-aware circuitry 408 the camera that the processor uses to determine a field of view (FOV) for image sensor 406. For example, processor 402 may receive a compass heading from context-aware circuitry 408 to determine a direction that image sensor 406 is facing. In another embodiment of the present invention, additional information may be obtained (for example, level and location) to determine the image sensor's FOV. This information then is provided to computer 116, which may also maintain, in at least one memory device 504, a location of RSM 118. Based on the determined direction that image sensor 406 is facing and the location of RSM 118, computer 116 is able to determine whether RSM 118 is in the FOV of image sensor 406.

In response to determining that a remote microphone, such as microphone 232 of MS 104 or microphone 332 of RSM 106 or RSM 118, or a user of such a microphone, that is, user 108, is within a FOV of camera 112, vehicle-based communication system 110 instructs (708) the remote microphone to configure itself to receive ambient audio, for example, by conveying a first configuration message to the remote microphone. In response to receiving the instruction, the remote microphone configures (710) itself to receive ambient audio and begins transmitting (712) to vehicle-based communication system 110, and the vehicle-based communication system receives from the remote microphone, for example, via base station 114, ambient audio. Vehicle-based communication system 110 then routes the received ambient audio to computer 116 or camera 112 and the computer or camera stores (714) the received ambient audio in association with the recorded images, for example, in at least one memory device 404 of computer 116 or in at least memory device 504 of camera 112. Preferably, the video and ambient audio are synched up and stored together; however, in other embodiments of the present invention, the video and audio may each be time-stamped and stored separately for subsequent combining.

In one such embodiment, vehicle-based communication system 110 may instruct the remote microphone to configure itself to receive ambient audio in response to determining both that (1) the remote microphone 104/106/118 or the user 108 is within a FOV of the camera and (2) that camera 112 has started recording the captured images. For example, camera 112 may determine that the remote microphone or user is within a FOV of the camera and further determine that it has started recording, or computer 116 may determine that the remote microphone or user is within a FOV of the camera 112 and may receive an indication from the camera that the camera has started recording, for example, by receiving an indicator in a message or by receiving the images themselves for storage at the computer. In another such embodiment of the present invention, computer 116 may assume that camera 112 already has started recording, for example, that the camera is always recording or that recording is initiated (for example, by the user) when user 108 leaves the vehicle, and need only determine whether the remote microphone 104/106/118 or the user 108 is within a FOV of the camera.

Further, in an embodiment of the present invention, the remote microphone may configure itself to receive ambient audio only after a determination that the remote microphone is not actively engaged in a communication session with the user. In one such embodiment, if the remote microphone is on user 108, for example, remote microphones 232 and 332 of MS 104 and RSM 106, and detects that user 108 is depressing a PTT key or otherwise transmitting audio via a radio or other wide area transceiver, then the remote microphone might not configure itself to receive ambient audio, or might delay configuring itself to receive ambient audio until after the user releases the key or the radio completes its transmission of audio via a wide area transceiver. In another such embodiment, if computer 116 determines that the remote microphone is actively engaged in a communication session with user 108, for example, by detecting signaling indicating that the user has reserved a floor of a communication session and/or expressly detecting the user speaking into the remote microphone, then the computer might not instruct the remote microphone to configure itself to receive ambient audio, or might delay instruct the remote microphone to configure itself to receive ambient audio until after the computer determines that the user has released the floor of the communication session.

In one embodiment of the present invention, the remote microphone 232/332 may configure itself to receive ambient audio by adjusting the beam forming algorithm for the corresponding microphones 232 and selection of the corresponding antenna 208, 316 to transmit the microphone output. For example, the remote microphone may switch the microphone configuration from a directional beam forming pattern, designed to receive audio from a user speaking directly into the microphone, to an omni-directional configuration designed to pick up all ambient audio. By way of another example, the remote microphone may adjust a beam pattern null to cancel noise from any direction as opposed to noise from a particular direction. In another embodiment of the present invention, in addition or instead of adjusting a beam pattern, the remote microphone may configure itself to receive ambient audio by adjusting a noise cancellation algorithm to reduce an amount of background audio that may be canceled due to a detection of such audio as noise. In such instances, the first configuration message may explicitly instruct the remote microphone to adjusting a beam pattern and/or a noise cancellation algorithm to facilitate reception, by the remote microphone, of ambient audio, or the remote microphone may self-select a reconfiguration, such as an adjustment of a beam pattern and/or a noise cancellation algorithm, that will facilitate reception, by the remote microphone, of ambient audio.

In still another embodiment of the present invention, computer 116, at step 706, may execute an algorithm for acoustic management of multiple microphones, as known in the art and maintained in at least one memory device 404, and coordinate a reception of ambient audio by multiple remote microphones, such as microphones 118 and one of microphones 332 of MS 104 and RMS 106, and instruct the multiple microphones to configure themselves accordingly.

When vehicle-based communication system 110 subsequently determines (716) that the remote microphone, or the user of the remote microphone, has moved outside of the FOV of camera 112, or that the user of the remote microphone has actively engaged in a communication session using the remote microphone, for example, has pushed the PTT key of the remote microphone, then the vehicle-based communication system may instruct (718) the remote microphone to reconfigure itself to receive user directed audio, for example, by conveying a second configuration message to the remote microphone, which second configuration message, similar to the first configuration message, may or may not explicitly instruct the remote microphone to readjust the beam pattern or noise cancellation algorithm to facilitate reception of user directed audio (from the user). Logic flow diagram 700 then ends (720).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for controlling a remote microphone, the method comprising:
determining that one or more of the remote microphone and a user of the remote microphone is in a field of view (FOV) of a video camera; and
in response to determining that one or more of the remote microphone and the user is in the FOV, instructing the remote microphone to configure itself to receive ambient audio.

2. The method of claim 1, further comprising, in response to instructing the remote microphone to configure itself, configuring the remote microphone to receive ambient audio.

3. The method of claim 2, wherein configuring the remote microphone to receive ambient audio comprises adjusting a beam pattern of the remote microphone.

4. The method of claim 2, wherein configuring the remote microphone to receive ambient audio comprises adjusting a noise cancellation algorithm at the remote microphone.

5. The method of claim 1, further comprising, in response to instructing the remote microphone to configure itself, receiving ambient audio from the remote microphone.

6. The method of claim 5, further comprising storing the received ambient audio in association with corresponding recorded video images.

7. The method of claim 1, further comprising:
subsequent to determining that one or more of the remote microphone and a user of the remote microphone is in a field of view (FOV), determining that the one or more of the remote microphone and the user of the remote microphone no longer is in the FOV; and
in response to determining that the one or more of the remote microphone and the user of the remote microphone no longer is in the FOV, instructing the remote microphone to reconfigure itself to receive user directed audio.

8. The method of claim 1, further comprising determining whether a user is actively engaged in a communication session using the remote microphone and wherein instructing the remote microphone to configure itself to receive ambient audio comprises instructing the remote microphone to configure itself to receive ambient audio in response to determining that the user is not actively engaged in a communication session using the remote microphone.

9. The method of claim 8, further comprising:
subsequent to instructing the remote microphone to configure itself to receive ambient audio, determining that the user is actively engaged in a communication session using the remote microphone; and
in response to determining that the user is actively engaged in a communication session using the remote microphone, instructing the remote microphone to reconfigure itself to receive user directed audio.

10. The method of claim 1, further comprising determining a video camera has begun recording video images and wherein instructing the remote microphone to configure itself to receive ambient audio comprises instructing the remote microphone to configure itself to receive ambient audio in response to determining that the video camera has begun recording video images.

11. A vehicle-based communication system capable of controlling a remote microphone, the vehicle-based communication system comprising:
a video camera; and
a processor that is configured to:
determine, by reference to the video camera, that one or more of the remote microphone and a user of the remote microphone is in a field of view (FOV); and
in response to determining that one or more of the remote microphone and the user is in the FOV, instruct the remote microphone to configure itself to receive ambient audio.

12. The vehicle-based communication system of claim 11, wherein the processor is configured to instruct the remote microphone to configure itself to receive ambient audio by instructing the remote microphone to adjust the beam forming algorithms.

13. The vehicle-based communication system of claim 11, wherein the processor is configured to instruct the remote microphone to configure itself to receive ambient audio by instructing the remote microphone to adjust a noise cancellation algorithm.

14. The vehicle-based communication system of claim 11, wherein the processor further is configured to, in response to instructing the remote microphone to configure itself, receive ambient audio from the remote microphone.

15. The vehicle-based communication system of claim 14, wherein the vehicle-based communication system further comprising an at least one memory device and wherein the processor further is configured to store, in the at least one memory device, the received ambient audio in association with corresponding video images recorded by, and received from, the video camera.

16. The vehicle-based communication system of claim 11, wherein the processor further is configured to:
subsequent to determining that one or more of the remote microphone and a user of the remote microphone is in a field of view (FOV), determine that the one or more of the remote microphone and the user of the remote microphone no longer is in the FOV; and
in response to determining that the one or more of the remote microphone and the user of the remote microphone no longer is in the FOV, instruct the remote microphone to reconfigure itself to receive user directed audio.

17. The vehicle-based communication system of claim 11, wherein the processor further is configured to determine whether a user is actively engaged in a communication session using the remote microphone and wherein the processor is configured to instruct the remote microphone to configure itself to receive ambient audio by instructing the remote microphone to configure itself to receive ambient audio in response to determining that the user is not actively engaged in a communication session using the remote microphone.

18. The vehicle-based communication system of claim 17, wherein the processor further is configured to:
subsequent to instructing the remote microphone to configure itself to receive ambient audio, determine that the user is actively engaged in a communication session using the remote microphone; and
in response to determining that the user is actively engaged in a communication session using the remote microphone, instruct the remote microphone to reconfigure itself to receive user directed audio.

19. The vehicle-based communication system of claim 11, wherein the processor further is configured to determine that the video camera has begun recording video images and wherein the processor is configured to instruct the remote microphone to configure itself to receive ambient audio by instructing the remote microphone to configure itself to receive ambient audio in response to determining that the video camera has begun recording video images.

20. The vehicle-based communication system of claim 11, wherein the processor resides in the video camera.
